(19) United States
(12) Patent Application Publication
(10) Pub. No.: US 2011/0246590 A1
(43) Pub. Date: Oct. 6, 2011

(54) METHOD, SERVER, INSTANT MESSAGING CLIENT, AND SYSTEM OF INSTANT MESSAGING

(75) Inventor: Thijs Terlouw, Shenzhen (CN)

(73) Assignee: TENCENT TECHNOLOGY (SHENZHEN) COMPANY LIMITED, Shenzhen (CN)

(21) Appl. No.: 13/160,603

(22) Filed: Jun. 15, 2011

Related U.S. Application Data
(63) Continuation of application No. PCT/CN2009/075554, filed on Dec. 14, 2009.

(30) Foreign Application Priority Data
Dec. 24, 2008 (CN) CN200810240910.1

(51) Int. Cl. G06F 15/16

(52) U.S. Cl. 709/206

(57) ABSTRACT

A method for instant messaging includes: receiving social information which includes a type identification of a social information event, contents of the social information event and an initiator of the social information event; obtaining a type of the social information event and a proposed user action for the type of the social information event by utilizing the type identification of the social information event; and transmitting the social information, the type of the social information event and the proposed user action to an Instant Messaging (IM) client; displaying, by the IM client, at least one of the initiator, the contents and the type of the social information event and the proposed user action. Accordingly, a server, an IM client and a system for instant messaging are provided. By gathering all social information received by a user, the user is able to trace all activities by performing the least interactions.

### FIELD OF THE INVENTION

The present invention relates to communications technology, and more particularly, to a method, server, client and system for Instant Messaging (IM).

### BACKGROUND OF THE INVENTION

Currently, instant messenger is a type of communication tools popular among people. People can communicate with each other instantly via an IM client. Besides chatting, which is the most commonly-used IM service, people also hope to use other types of IM services, e.g., obtaining at earliest time a buddy's up-to-date personal data, photos submitted, updated blog articles and so on. The above listed are information which people hope to obtain instantly, and this kind of information is called social information.

Social information includes all “events” received by an IM client one after another in time order. The events include but not limited to: chatting information, state update, basic data change, a received e-mail and a change of scenario, etc. Besides, activities which require interaction between users, such as accepting an uploaded file and so on, are also included in social information.

When conceiving embodiments of the present invention, the inventor finds the prior art having the following disadvantages.

In current IM systems, a user may need to click on different objects to browse different types of social information, and have to obtain the social information in various manners. As a result, the user needs to do a lot of interactions, which greatly distracts the attention of the user and adds burden to the user.

### SUMMARY OF THE INVENTION

The present invention provides a method, server, client and system for instant messaging, which frees a user from frequent interactions for obtaining varieties of social information.

Technical schemes provided are as follows.

A method for instant messaging includes:

receiving social information which includes a type identification of a social information event, contents of the social information event and an initiator of the social information event;

obtaining a type of the social information event and a proposed user action for the type of the social information event by utilizing the type identification of the social information event; and

transmitting the social information, the type of the social information event and the proposed user action to an IM client; and

displaying, by the IM client, at least one of the initiator of the social information event, the contents of the social information event, the type of the social information event and the proposed user action.

A server includes:

a receiving module, configured for receiving social information which includes a type identification of a social information event, contents of the social information event and an initiator of the social information event;

an obtaining module, configured for obtaining a type of the social information event and a proposed user action for the type of the social information event by utilizing the type identification of the social information event;

a transmitting module, configured for transmitting the social information, the type of the social information event and the proposed user action to an IM client.

An Instant Messaging (IM) client includes:

a receiving module, configured for receiving social information, a type of a social information event and a proposed user action for the type of the social information event which are transmitted by a server; and

a displaying module, configured for displaying at least one of the social information, the type of the social information event and the proposed user action which are received by the receiving module.

An Instant Messaging (IM) system includes a server and an IM client;

wherein the server is configured for:

receiving social information which includes a type identification of a social information event, contents of the social information event and an initiator of the social information event;

obtaining a type of the social information event and a proposed user action for the type of the social information event by utilizing the type identification of the social information event;

transmitting the social information, the type of the social information event and the proposed user action to the IM client;

wherein the IM client is configured for:

displaying at least one of the initiator of the social information event, the contents of the social information event, the type of the social information event and the proposed user action.

The technical scheme has advantages of:

by gathering all social information obtained by a user, the user is allowed to trace all activities by performing the least interactions. All social information events can be displayed automatically in the order of reception time of the events. Furthermore, the user can choose a manner for displaying the social information events or choose to use the conventional IM communication manner, thus the technical scheme is more flexible.

### BRIEF DESCRIPTION OF THE DRAWINGS

FIG. 1 is a flowchart illustrating a method for instant messaging in accordance with embodiment 1 of the present invention.

FIG. 2 is a flowchart illustrating a method for displaying a social information event in accordance with embodiment 1 of the present invention.

FIG. 3 is a schematic illustrating a structure of a system for instant messaging in accordance with embodiment 2 of the present invention.

FIG. 4 is a schematic illustrating a structure of a server in accordance with embodiment 2 of the present invention.

FIG. 5 is a schematic illustrating a structure of a server in accordance with embodiment 2 of the present invention.

FIG. 6 is a schematic illustrating a structure of a server in accordance with embodiment 2 of the present invention.

FIG. 7 is a schematic illustrating a structure of a server in accordance with embodiment 2 of the present invention.

FIG. 8 is a schematic illustrating a structure of an IM client in accordance with embodiment 2 of the present invention.

### DETAILED DESCRIPTION OF THE INVENTION

To make the objective, technical scheme and merits of the present invention clearer, the present invention will be described hereinafter in detail with reference to accompanying drawings and embodiments.

### Embodiment 1

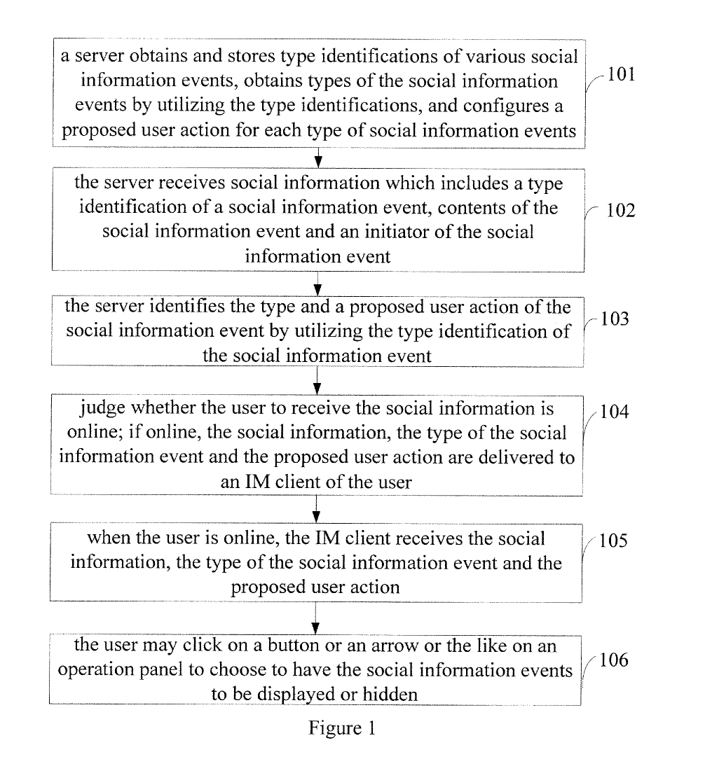

Referring to FIG. 1, this embodiment provides a method for instant messaging. Supposing a server carries out the method, the method may include the steps as follows.

In step 101, the server obtains and stores type identifications of various social information events, establishes types for the social information events according to the type identifications, and configures a proposed user action for each type of social information events.

There are many manners for the server to obtain the types of various social information events, e.g., by enumerating type identifications of known social information events and event types of the type identifications, or by defining type identifications for the social information events and the event types for the type identifications respectively.

The proposed user action is an action suggested by the server to be taken by a user of an IM client against a certain social information event. For example, when social information with type identification 0004 is received, the type of the social information event is defined as “a new e-mail is received” and the proposed action provided for the user is “read”.

The above information may be stored a relation table maintained in the server, which may be in the form of Table 1 below or other forms.

TABLE 1

| | | proposed user |
|---|---|---|
| | event type | action |
| 0001 | a buddy modified his user | read |
| | data | |
| 0002 | a buddy uploaded a photo | browse |
| 0003 | a buddy submitted a blog | make a comment |
| | article | |
| 0004 | a new e-mail is received | read |
| 0005 | a new message is received | reply |
| . . . | . . . | . . . |

In step 102, In step 102, the server receives social information which may include a type identification of a social information event, contents of the social information event and an initiator of the social information event.

The server may include a module dedicated to receiving chatting information and may further include a module dedicated to receiving other asynchronous events. This technique has been described in the conventional art and will not be described further.

Each social information event may have a transmission mode of “one to multiple” or “one to one”. For example, the chatting information may be transmitted to one buddy or to a group of buddies. When a user updates a blog, the social information event is allocated with the transmission mode of “one to multiple”. Thus, all buddies of the user can receive the social information event. When a user receives an e-mail, the system may transmit information of the e-mail only to the user.

In step 103, the server configures a type and a proposed user action for the social information event according to the type identification of the social information event in the social information.

Specifically, the server first searches in already-obtained type identifications of the social information events for the received type identification of the social information event.

If the received type identification is found, the server directly obtains the type and the proposed user action of the social information event.

If the received type identification is not found, the server defines a special event type for the received type identification and provides a proposed user action for the special event type.

In step 104, it is checked whether a user to receive the social information is online. If the user is online, the social information, the type of the social information event and the proposed user action are delivered to an IM client of the user. If the user is offline, the social information, the type of the social information event and the proposed user action are stored, and delivered to the IM client of the user later when the user gets online.

Being online refers to a state in which the user is communicating with the Internet via the IM client.

In step 105, when the user to receive the social information is online, the IM client receives the social information, the type of the social information event and the proposed user action.

The IM client may first store the social information, the type of the social information event and the proposed user action, sort all social information according to a pre-set rule, such as according to the order of reception time (i.e. place the most-recently-received social information at the top place), and display all the social information.

The manner of the IM client receiving the social information event may be the same with that of the IM client receiving chatting information and other events such as tips.

For the received type identifications which are undefined, the IM client needs to define the type identification to ensure that the IM client can differentiate and display different events.

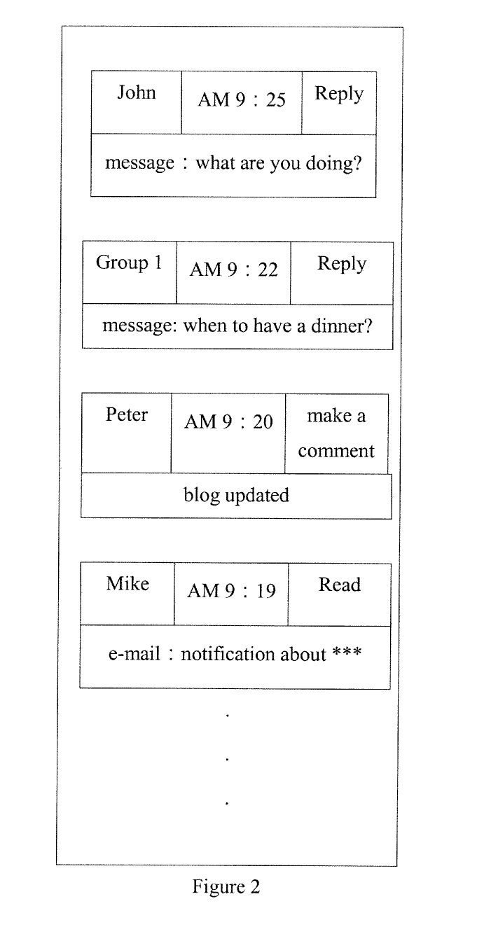

Referring to FIG. 2, displayed information of each social information event may include:

(A) the initiator of the social information event, which may include the name or logo of a personal user or a category of users or a chat group, such as John or Group 1 as shown in FIG. 2;

(B) event type, which may be presented using a graphic or using text such as a message or an e-mail as in FIG. 2;

(C) reception time, which may be an absolute time or the time elapsed;

(D) proposed action, such as reply the chatting information, or make a comment on a buddy's blog which was just updated, or read an e-mail.

In step 106, the user may click on a button or an arrow or the like on an operation panel to choose to have the social information events displayed or hidden.

When the user chooses to have the social information events hidden, the user may perform interactions according to conventional IM manners.

When the user chooses to have the social information events displayed, the user obviously hopes to see updated social information. Therefore, when the user receives a message or other events, his IM state will not be changed. The most recently received social information event will be pushed to the top of all social information. Therefore, the user can make less effort because all social information events can be immediately seen without a click to obtain the events one by one. In addition, the user can easily choose which events are to be omitted and which events are to be processed immediately. Even if the user is busy working or is away, he will not miss any social information event.

When the user chooses to have the social information events displayed, the user may select a certain type of social information events that are to be received or displayed, or may follow a default manner, e.g., when a user chooses a default manner, receiving or displaying of Taotao, Qzone or e-mail is activated.

The user may choose to have only the most recent social information events displayed, or may choose to display social information events occurred within a period of time. In addition, the user may further determine the number of the social information events to be displayed, such as the most recent 50 events or all events occurred within an hour.

The user may delete an event from all the social information events or delete all social information.

In embodiments of the present invention, all the social information events received by the user are collected, which allows the user to trace all events through the least interactions. All the social information events may be automatically displayed in the order of the time when the social information events are received. In addition, the user may choose the manner of displaying the social information events or choose a conventional IM method for performing communications in this embodiment. Therefore, the method of this embodiment is flexible.

### Embodiment 2

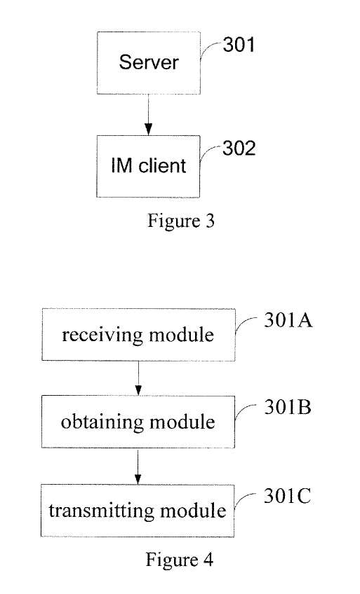

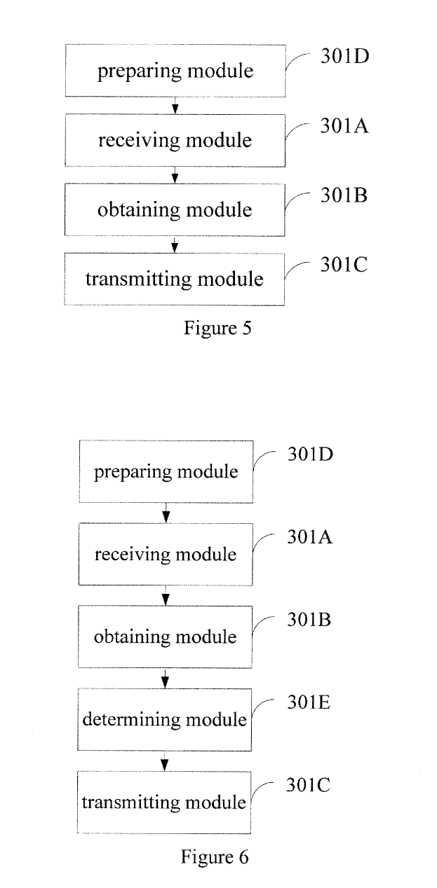

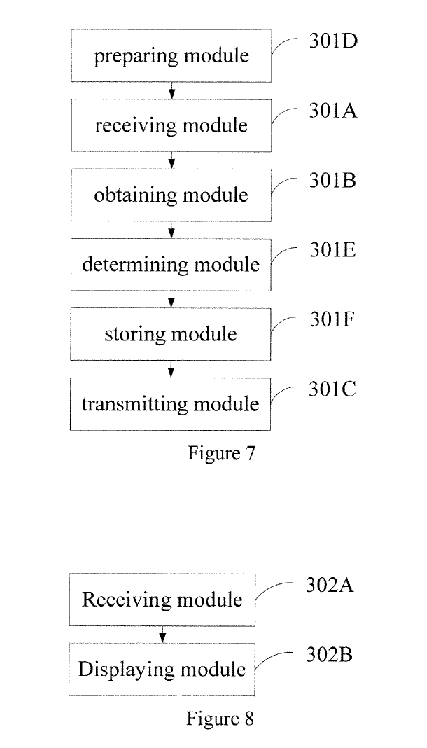

FIG. 3 is a schematic illustrating a structure of a system for instant messaging in this embodiment of the present invention. As shown in FIG. 3, the system may include a server 301 and an IM client 302.

The server 301 is configured for receiving social information, which includes a type identification of a social information event, contents of the social information event and an initiator of the social information event;

obtaining a type of the social information event and a proposed user action by utilizing the type identification of the social information event; and

transmitting the social information, the type of the social information event and the proposed user action to the IM client 302.

The IM client 302 is configured for displaying at least one of the initiator of the social information event, the contents of the social information event, the type of the social information event and the proposed user action.

As shown in FIG. 4, the server 301 of an embodiment may include:

a receiving module 301A, configured for receiving social information which includes a type identification of a social information event, contents of the social information event and an initiator of the social information event;

an obtaining module 301B, configured for obtaining the type of the social information event and a proposed user action by utilizing the type identification of the social information event; and

a transmitting module 301C, configured for transmitting the social information, the type of the social information event and the proposed user action to the IM client 302.

Furthermore, the server 301 of an embodiment may also include:

a preparing module 301D, configured for obtaining type identifications of multiple types of social information events, establishing types for the social information events according to the type identifications and configuring a proposed user action for each type of social information events.

According to an embodiment, the server 301 may also include:

a determining module 301E, configured for determining whether the IM client 302 has logged onto a network.

Specifically, the transmitting module 301C is configured for transmitting the social information, the type of the social information event and the proposed user action to the IM client 302 when the determining module 301E determines that the IM client has logged onto the network.

According to an embodiment, when the determining module 301E determines that the IM client has not logged onto the network, the IM client may also include:

a storing module 301F, configured for storing the social information, the type of the social information event and the proposed user action.

Accordingly, the transmitting module 301C may be configured for: transmitting the social information, the type of the social information event and the proposed user action to the IM client 302 when the IM client has logged onto the network.

The IM client 302 of an embodiment of the present invention may also include:

a receiving module 302A, configured for receiving the social information, the type of the social information event and the proposed user action which are transmitted by the server 301; and

a displaying module 302B, configured for displaying at least one of the social information, the type of the social information event and the proposed user action which are received by the receiving module 302A.

Specifically, the displaying module 302B is configured for displaying at least one of the initiator of the social information event, the contents of the social information event, the type of the social information event and the proposed user action in the order of time when the social information events are received.

Through the IM system of embodiments of the present invention, all social information events received by the user are put together, which allows the user to trace all events through least interactions. All messages may be displayed automatically according to the order of time when the social information events are received. In addition, the user may choose the manner of displaying the social information events or choose to use the conventional IM method of performing communications, thus the solution of the embodiments is flexible.

The embodiments of the present invention may be implemented by software. Software programs may be stored in a readable storage medium, such as a hard disk, cache or CD in a router.

The foregoing is only embodiments of the present invention. The protection scope of the present invention, however, is not limited to the above description. All the modifications, equivalent replacements or improvements, which can be easily obtained by those skilled in the art, are included within the protection scope of the present invention.

What is claimed is:

1. A method for instant messaging, comprising:
receiving social information which includes a type identification of a social information event, contents of the social information event and an initiator of the social information event;
obtaining a type of the social information event and a proposed user action for the type of the social information event by utilizing the type identification of the social information event; and
transmitting the social information, the type of the social information event and the proposed user action to an Instant Messaging (IM) client to display at least one of the initiator, the contents and the type of the social information event and the proposed user action.

2. The method of claim 1, further comprising:
obtaining type identifications of a plurality of types of social information events, establishing types for the social information events according to the type identifications, and configuring a proposed user action for each type of social information event.

3. The method of claim 1, further comprising:
determining whether the IM client has logged onto a network before transmitting the social information, the type of the social information event and the proposed user action to the IM client;
wherein transmitting the social information, the type of the social information event and the proposed user action to the IM client comprises:
transmitting the social information, the type of the social information event and the proposed user action to the IM client when the IM client has logged onto the network.

4. The method of claim 3, further comprising: storing the social information, the type of the social information event and the proposed user action when the IM client has not logged onto the network;
wherein transmitting the social information, the type of the social information event and the proposed user action to the IM client comprises:
transmitting the social information, the type of the social information event and the proposed user action to the IM client when the IM client has logged onto the network.

5. The method of claim 1, further comprising:
displaying, by the IM client, at least one of the initiator, the contents and the type of the social information event and the proposed user action in the order of time when the social information events are received.

6. A server, comprising:
a receiving module, configured for receiving social information which includes a type identification of a social information event, contents of the social information event and an initiator of the social information event;
an obtaining module, configured for obtaining a type of the social information event and a proposed user action for the type of the social information event by utilizing the type identification of the social information event;
a transmitting module, configured for transmitting the social information, the type of the social information event and the proposed user action to an Instant Messaging (IM) client.

7. The server of claim 6, further comprising:
a preparing module, configured for obtaining type identifications of a plurality of types of social information events, establishing types for the social information events according to the type identifications, and establishing a proposed user action for each type of social information event.

8. The server of claim 6, further comprising:
a determining module, configured for determining whether the IM client has logged onto a network;
wherein the transmitting module is configured for transmitting the social information, the type of the social information event and the proposed user action to the IM client when the determining module generates a determining result that the IM client has logged onto the network.

9. The server of claim 8, further comprising: a storing module when the determining module generates a determining result that the IM client has logged onto the network;
wherein the storing module is configured for storing the social information, the type of the social information event and the proposed user action;
wherein the transmitting module is configured for transmitting the social information, the type of the social information event and the proposed user action to the IM client when the IM client has logged onto the network.

10. An Instant Messaging (IM) client, comprising:
a receiving module, configured for receiving social information, a type of a social information event and a proposed user action for the type of the social information event which are transmitted by a server; and
a displaying module, configured for displaying at least one of the social information, the type of the social information event and the proposed user action which are received by the receiving module.

11. The IM client of claim 10, wherein the displaying module is configured for displaying at least one of the initiator, contents and the type of the social information event and the proposed user action in the order of time when social information events are received.
